(19) United States
(12) Patent Application Publication
(10) Pub. No.: US 2016/0309062 A1
(43) Pub. Date: Oct. 20, 2016

(54) METROLOGY CAROUSEL DEVICE FOR HIGH PRECISION MEASUREMENTS

(71) Applicant: AppBANC, LLC, Santa Clara, CA (US)

(72) Inventor: Gilbert SPRINGER, Fremont, CA (US)

(21) Appl. No.: 15/130,839

(22) Filed: Apr. 15, 2016

Related U.S. Application Data
(60) Provisional application No. 62/147,999, filed on Apr. 15, 2015.

(51) Int. Cl. H04N 5/225; G01B 11/28; G01B 11/02; G02B 7/16; H04N 5/232

(52) U.S. Cl. CPC H04N 5/2252; G02B 7/16; H04N 5/2256; H04N 5/23293; G01B 11/02; G01B 11/285

(57) ABSTRACT

A system and method for performing high precision measurements are disclosed. In a first aspect, the system comprises a metrology carousel device that comprises a body device and a carousel device coupled to the body device. The carousel device includes a lens located between a twin tower component, wherein the twin tower component is used to beam light onto a subject to perform the high precision measurements. In a second aspect, the method comprises providing a system that comprises a body device and a carousel device coupled to the body device, wherein the carousel device includes a lens located between a twin tower component, and beaming a light onto a subject using the twin tower component to perform the high precision measurements.

### CROSS-REFERENCE TO RELATED APPLICATION

This application claims benefit under 35 U.S.C. 119(e) of U.S. Provisional Patent Application No. 62/147,999, filed on Apr. 15, 2015, entitled “METHOD AND SYSTEM FOR OPTICAL MEASUREMENT USING A LENS WITH SOFTWARE ATTRIBUTES,” which is incorporated herein by reference in its entirety.

### FIELD OF THE INVENTION

The present invention relates to high precision measurements, and more particularly, to a metrology carousel device for high precision measurements.

### BACKGROUND

Metrology is the science of measurement and includes all practical aspects of measurement. Metrology can be utilized to ensure that calibrated instruments deliver accurate results and to maintain measurement standards. Conventional metrology devices are costly and not easily attachable to various mobile devices such as smartphones. Therefore, there is a strong need for a cost-effective solution that overcomes the above issues. The present invention addresses such a need.

### SUMMARY OF THE INVENTION

A system and method for performing high precision measurements are disclosed. In a first aspect, the system comprises a metrology carousel device that comprises a body device and a carousel device coupled to the body device. The carousel device includes a lens located between a twin tower component, wherein the twin tower component is used to beam light onto a subject to perform the high precision measurements.

In a second aspect, the method comprises providing a system that comprises a body device and a carousel device coupled to the body device, wherein the carousel device includes a lens located between a twin tower component, and beaming a light onto a subject using the twin tower component to perform the high precision measurements.

### BRIEF DESCRIPTION OF THE DRAWINGS

The accompanying figures illustrate several embodiments of the invention and, together with the description, serve to explain the principles of the invention. One of ordinary skill in the art will recognize that the particular embodiments illustrated in the figures are merely exemplary, and are not intended to limit the scope of the present invention.

FIG. 1 illustrates a metrology carousel device in accordance with an embodiment.

FIG. 2 illustrates a live screen view using the metrology carousel device in accordance with an embodiment.

FIG. 3 illustrates a still photograph view using the metrology carousel device in accordance with an embodiment.

FIG. 4 illustrates a still photograph view using the metrology carousel device in accordance with another embodiment.

FIG. 5 illustrates a lens calibration view using the metrology carousel device in accordance with an embodiment.

FIG. 6 illustrates a method for performing high precision measurements using a metrology carousel device in accordance with an embodiment.

### DETAILED DESCRIPTION OF PREFERRED EMBODIMENTS

The present invention relates to high precision measurements, and more particularly, to a metrology carousel device for high precision measurements. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

Instruments require calibration to ensure that they are working properly. Metrology ensures that calibrated instruments deliver accurate results by enabling the recordation of high precision measurements. The high precision measurements are utilized to calibrate the instruments against known standards that the results can be trusted to have a universally accepted meaning.

A system and method in accordance with the present invention provides a metrology carousel device (including but not limited to the WOW metrology carousel device) for high precision measurements. The metrology carousel device enables the recordation of high precision measurements using a plurality of lenses which ensures the proper calibration of various instruments and devices. The metrology carousel device comprises a design that provides a means for recording high precision measurements. In one embodiment, the metrology carousel device is a photo recordable super-caliper with applications in industrial, medical, and utility purposes. The metrology carousel device can be used to measure the distance between two opposite sides of an object.

In one embodiment, the intended range of the high precision measurements recorded by the metrology carousel device is (1) in the micrometers (microns) and (2) in the micro-inch regime. The range of the measurements can either be live (macro-measurements not using any digital zooms) or eZoomed (micro-measurements using digital zooms). In one embodiment, the range of the measurements is extended by utilizing a plurality of other types of macro lens designs.

In one embodiment, the body of the metrology carousel device is incorporated into a smartphone case or a stand-alone lens with twin towers (a twin towner component comprising two projection towers located adjacent to each other and juxtaposed to the macro-lens portal that houses the macro-lens). The metrology carousel device contains a plurality of lenses for metrology and comprises a two layer (overlay) made of optical grade polycarbonate or other suitable materials. The optical polycarbonate material is injected into or can be inserted/filled into the channels that connectively illuminate the twin towers.

In this embodiment, the twin towers project light patterns onto a subject (that is within the macro-lens view field) and/or one or more umbra images. The diameters of the light patterns are modulated as a function of the viewed subject's distance from the macro-lens. The focal plane that establishes the correct calibration is determined when circles projected onto the macro-lens view field invade the semi-transparent rectangles (transparent compound stripe-bar) that are also projected. In one embodiment, the semi-transparent rectangles utilize two rectangle zones and in another embodiment, more than two are used. Two precision levels can be determined by the distance of the calibration plane using the outer rectangle and/or the inner rectangle. The user may predetermine which rectangle (outer or inner) will be used to establish varying levels of precision.

In this embodiment, software in communication with the metrology carousel device enables auto-snaps of the viewed subject/scene by sensing an invasion of the twin light beams onto a triangle area which sets a precision of measurement and the one or more umbra images. The umbra images define a focal plane of interest, coinciding with calibrations for measurements. The metrology carousel device includes a macro-lens (as one of the plurality of lenses) that can be calibrated with scales, angles, and circles and the plurality of lenses are rotatable so that the user can interchange between them during usage (i.e., switch the usage from one lens to another). The metrology carousel device also includes a focal plane detector coupled to the twin towers that can either have its own internal light source or can utilize a light source from the smartphone.

In this embodiment, the metrology carousel device has two main components which are the main body and the carousel device itself that includes the plurality of lenses and an optical grade channel overlay that acts as a light pipe to defractor pipe towers during spot converging for Z-axis calibration.

In one embodiment, the user can download a software application (app) via the smartphone device which interacts with the metrology carousel device's view field and the plurality of lenses to provide variable and static scalar measurements. In this embodiment, a scalar calibration image viewed by the metrology carousel device is transmitted as a graphic user interface (GUI) object viewed on the screen of the smartphone device with selectable options enabling the user to choose a metric system for measurements of magnitudes, angles, and shapes. The scalar calibration image can be configured to mimic static lens calibrations and can be rotatable. The scalar calibration image can be used for open field of view measurements subject to focal plane calibrations. The lens calibrations can be fixed on the lens for close measurements including linear, angles, curves, squares, and circles.

A system and method in accordance with the present invention provides a metrology carousel device for high precision measurements. The metrology carousel device comprises a plurality of lenses including but not limited to a carousel-mounted macro-lens that communicate and are controlled by a software application (app) on a mobile device (e.g., smartphone) to perform the high precision measurements. In another embodiment, only the macro-lens communicates with the app. The metrology carousel device (and the plurality of lenses specifically) and the app communicate with each other using any of Wi-Fi, Bluetooth, and other similar communication technologies.

To describe the features of the present invention in more detail, refer now to the following description in conjunction with the accompanying Figures.

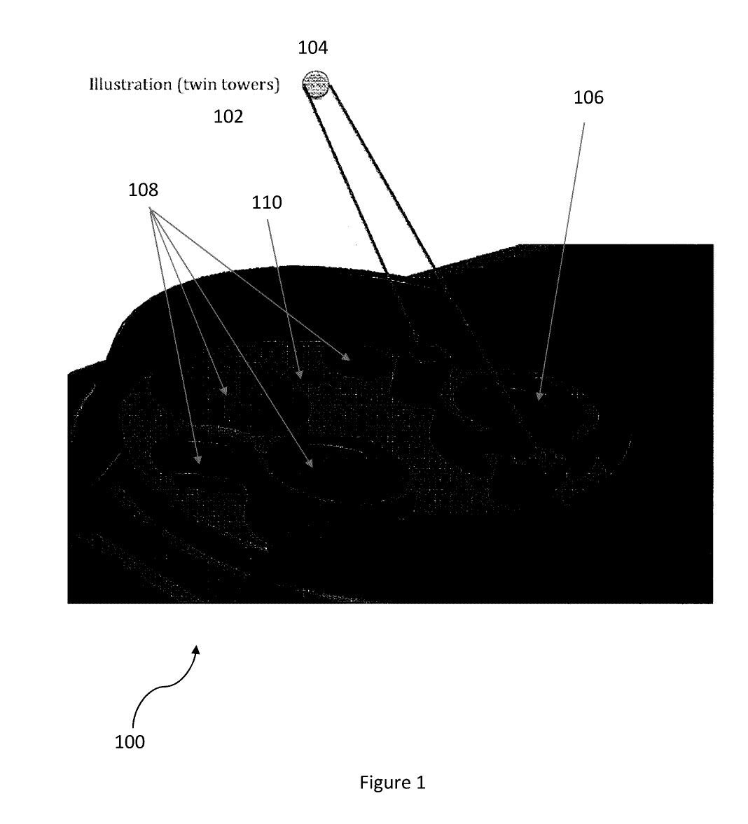

FIG. 1 illustrates a metrology carousel device 100 in accordance with an embodiment. The metrology carousel device 100 includes a lens 104 (e.g., a tower lens) embedded within each projection tower of a twin tower component 102 and a macro-lens 106 coupled in between each projection tower of the twin tower component 102. The metrology carousel device 100 also includes a plurality of other lenses 108 that include but are not limited to macro-lenses, micro-lenses, wide-angle lenses, and polarized neutral density/filter lenses. In addition, the metrology carousel device 100 includes an opening 110 that accommodates the host device's (e.g., smartphone's) flash and microphone devices.

In one embodiment, the metrology carousel device 100 comprises a multiple-lens/function carousel mounted on a case that mounts on a smartphone, enabling each lens to be located congruent to the smartphone's camera lens. In FIG. 1, the twin tower component 102 projects beam of light into the view field of the macro-lens 106 housed within a cylindrical portal. The plurality of other lenses 108, the opening 110, and the twin tower component 102 are cylindrical devices that contain other optics not related to the macro function of the macro-lens 106.

In one embodiment, a user can interchange between the plurality of other lenses 108 by rotating the metrology carousel device 100 that has been securely coupled to the host device. In one embodiment, the metrology carousel device 100 is coupled to a host device including but not limited to a mobile device (e.g., smartphone) either directly (i.e., metrology carousel device 100 coupled to the smartphone) or indirectly via a case (i.e., metrology carousel device 100 coupled to a smartphone case and the smartphone case is coupled to the smartphone). In another embodiment, the host device includes any of an Apple iPhone 6, an Apple iPhone 6S, an alternative platform smartphone, pads and similar camera mounted intelligence devices, a phone camera, a remote camera, and a dual camera smartphone.

In one embodiment, the metrology carousel device 100 communicates with the host device via a software application. In one embodiment, the software application comprises a free version (e.g., eZoom) and a premium paid version (e.g., eZoom Pro/Metrology) that has additional features and capabilities for the user to utilize. In one embodiment, the metrology carousel device 100 is directly coupled to the host device via an attachment mechanism. In another embodiment, the metrology carousel device 100 is integrated within and coupled to a host device case (e.g., smartphone case) and then the case is coupled to the host device. In either coupling mechanism, the metrology carousel device 100 is coupled over the embedded camera(s) of the host device to ensure proper functioning of the camera(s).

In one embodiment, the metrology carousel device 100 has a live screen mode/view (using the macro-lens), a live snap first but measure later mode (using a combination of lenses), and a still from a library mode or ‘still photo library mode’ (using the micro-lens). In one embodiment, the metrology carousel device 100 further includes a metric display in addition to the metric carousel that comprises the lens 104 flanked by the twin tower component 102. The metric display (or measuring square module) is coupled to the macro-lens and is utilized to measure a square area around an object/subject that is in view. More specifically, the metric display of the metrology carousel device 100 is utilized by the user to measure an X axis of the square area, a Y axis of the square area, and an area of the square area. The metric display can interchange between the metric system and the English system.

In one embodiment, the metric display utilizes a plurality of square modes including but not limited to a live screen mode/view, a still photo library mode (still photo mode/view), an eZoom mode using the software app, and a streaming mode. The live screen mode comprises a live photo capability that enables the user to capture live photos and take high precision measurements without altering the scope of the photo using the macro-lens (also known as precision regime 1). The still photo library mode comprises a screen expanding photo capability using a digital set zoom that enables the user to zoom in/out of a still photo (also known as precision regime 2). The eZoom mode comprises a eZoom capability using the software app on the smartphone and a more-advanced digital set zoom that enables the user to zoom even further in/out of a photo (also known as precision regime 3). The streaming mode comprises an extended precision capability using compound translucence. In one embodiment, the macro-lens is coupled with the metric display which coordinates and communicates with the software app on the smartphone.

In one embodiment, the twin tower component 102 has a predetermined tower height (e.g., 0.25 to 2 centimeters), a predetermined cylindrical inner diameter and outer diameter, towers that are either movable or stationary which enables a coordinates variable focal range, a lite (or light) pipe LED illumination projection capability, and a lite (or light) pipe tower lens attached in-situ.

In one embodiment, the measuring square module is rotatable and utilized to take both still and live images. The measuring square module includes a translucent converge bar (e.g., a converge bar with either single or dual transparency), a beam converge auto-snap functionality using a button or action via the software app, a crop-square functionality using a button or action via the software app, a save functionality using a save button, and the ability to measure pixels, inches, and display a meter scale. In addition, the measuring square module includes an eZoom feature with a fixed magnification for eZoom metrics, an eZoom rotatable crop metric square functionality, and switchable units between the metric and English systems.

In one embodiment, the metric carousel (or metrology carousel device 100) utilizes at least one software coordinated lens (including but not limited to the macro-lends 106) and fits a plurality of smartphones including but not limited to the iPhone 6 and 6S. The case mounted metrology carousel device provides interchangeability for additional carousels to be attached that include other types of specific macro-lenses with specific magnification and reticle functions.

Referring back to FIG. 1, the macro-lens 106 mounted on the metrology carousel device 100 is flanked by the two projection towers of the twin tower component 102. In one embodiment, measurements are carried out by employing the macro-lens 106 and a live screen view of the subject to be measured. The measurement allows one of the semi-transparent rectangles to operate within its calibration range when it intersects the other of the semi-transparent rectangles thereby calibrating the macro-lens view field (or live view field or live screen view), and the live view field can project a solid or semitransparent reticle superimposed on the macro-lens view field.

The software coordinated lens of the macro-lens 106 allows twin beams of light to be projected onto the subject and the smartphone camera is positioned to converge the beams on the view field of the subject thereby establishing a correct focal length that calibrates the view field for coordinating the measuring scale.

In one embodiment, the first and second beams of light are both shined towards the focal object (or object being measured/focused upon) and the beam's height (diameter) expands (modulates) over increasing distances or as the beam gets closer to the object. The bottom plane of the first beam of light and the top plane of the second beam of light converge towards a focal plane event which enables the determination of the correct focal length for coordinating and complying with the calibration defined by the measuring scale. In one embodiment, the macro-lens 106 comprises an optical polycarbonate material.

In one embodiment, the method and system in accordance with the present invention that provides the metrology carousel device 100 is utilized for macro measurements, metric measurements (e.g., inches, meters), scaling with macro precision (e.g., inch—0.01 to 0.0001 and meter—0.001-0.0001), and more advanced scaling with eZoom (e.g., inch—0.0001 to 0.00001 and meter—0.00001 to 0.000001).

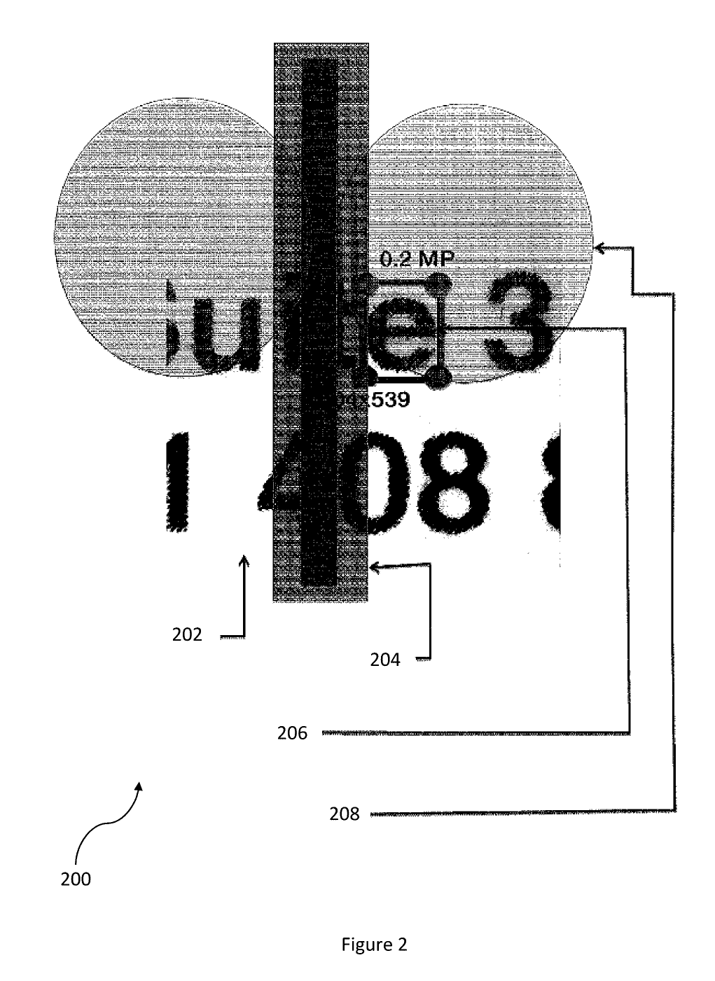

FIG. 2 illustrates a live screen view 200 using the metrology carousel device 100 in accordance with an embodiment. The live screen view 200 is accessed by using the macro-lens 106 of the metrology carousel device 100 in live screen mode using the software app that provides software generated rectangles invaded by the projected beams from the twin towers. The live screen view 200 includes a live view field 202 and the eZoom's transparent compound stripe-bar 204 that has dual transparency (denoted by the two color shades, one shade in the center and a second shade on the left and right sides of the center stripe).

The transparent compound stripe-bar 204 authenticates a metric precision focal range and then sets a calibrated focal length to authenticate the metric precision focal plane. The transparent compound stripe-bar 204 thereby allow additional significant digits when the circles invade. In FIG. 2, a macro-lens view field of the macro-lens 106 is superimposed with two software generated semitransparent rectangles of different transparencies coincident with two light circles projected onto the macro-lens view field.

The live screen view 200 further includes a measuring square module 206 (or measuring rotatable square) that enables selectable metrics (e.g., inches/meters) and performs precise measurements that are set by the transparent compound stripe-bar 204. In FIG. 2, the depicted measuring square module 206 is superimposed after the fact meaning it is operating on the photo-snapped view field and is manipulated over the view field measuring any features on the view field that are defined in that view field by the objects/subjects in sharp focus features defined by the view field focal length.

The measuring square module 206 has encompassed the letter “e” and the high precision measurements will be performed on this letter. The high precision measurements result in the top length of the square being measured as 0.2 megapixels (MP) but can be calibrated in metric system values or English system values. The live screen view 200 also includes two tower projected circles 208 from the two tower component 102 of the metrology carousel device 100. The two tower projected circles 208 from the snapped photo verifies which level of precision was selected by the user.

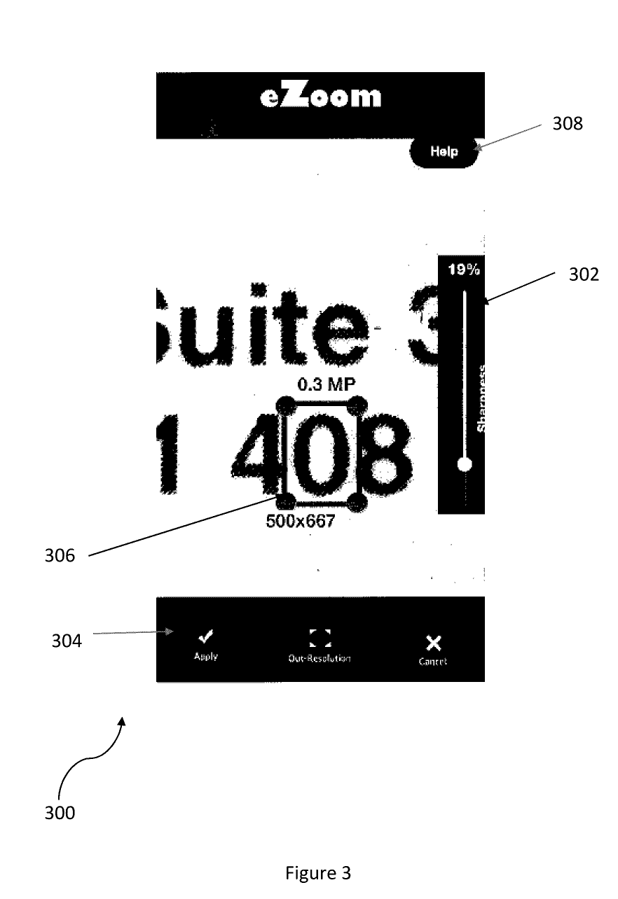

FIG. 3 illustrates a still photograph view 300 using the metrology carousel device 100 in accordance with an embodiment. The still photograph (photo) view 300 is accessed by using either the micro-lens of the metrology carousel device 100 in still photo library mode or the eZoom software app using the host device/smartphone in eZoom mode. The still photo view 300 utilizes precision zoom magnifications that are set by a live screen focus. The still photo view 300 includes a zooming module 302 and a plurality of buttons 304 accessible via the software app. In FIG. 3, the zoom or sharpness level has been set to 19% by the user using the zooming module 302. In one embodiment, the plurality of buttons 304 includes an apply button, an out of resolution button, and a cancel button. In another embodiment, the plurality of buttons 300 includes an undo button, an automatic focus button, and a commenting button.

The still photograph view 300 includes a measuring square module 306 similar to the measuring square module 206 from FIG. 2 that also enables selectable metrics (e.g., inches/meters). In FIG. 3, the measuring square module 306 has encompassed the number zero (0) for high precision measurements which result in the top length of the square being measured as 0.3 MP and the number of pixels within the square being measured as 500×667. The still photograph view 300 further includes a help button 308 where the user can garner instructions for how to use the eZoom software app and how to take the high precision measurements.

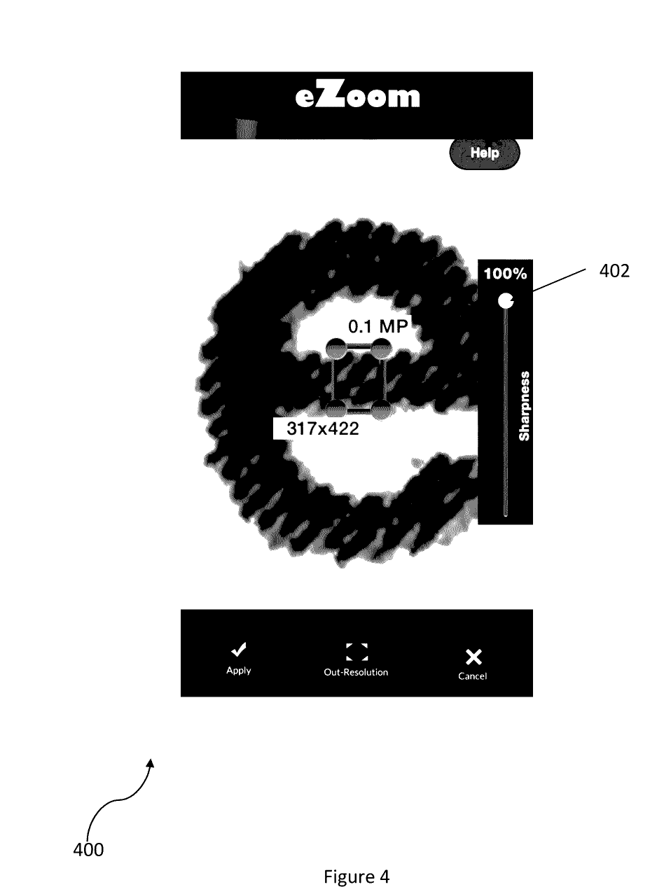

FIG. 4 illustrates a still photograph view 400 using the metrology carousel device 100 in accordance with another embodiment. The still photograph view 400 is similar to the still photograph view 300 of FIG. 3 and so the eZoom software app being utilized in FIG. 4 to generate the still photograph view 400 has the same characteristics and buttons as shown in FIG. 3. In FIG. 4, the user of the eZoom app has increased the sharpness or zoomed in functionality (via a zooming module 402 similar to the zooming module 302) to 100%. Therefore, the app has zoomed into the letter “e” that is being focused on for the high precision measurements.

Referring back to FIG. 2, the still photograph view 400 and the eZoom software app functionality enables a user to zoom in much further using the digital zoom to make even more high precision measurements. In comparison, the live screen view 200 of FIG. 2 shows a much smaller version of the letter “e” (compared with the much larger version of the letter “e” in the still photograph view 400) because the eZoom digital zooming functionality isn't utilized in FIG. 2 (only the macro-lens is utilized).

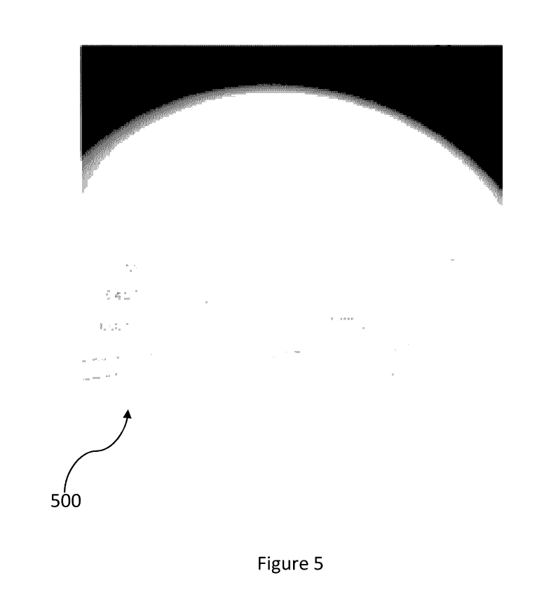

FIG. 5 illustrates a lens calibration view 500 using the metrology carousel device 100 in accordance with an embodiment. The lens calibration view 500 depicts a reticle including a plurality of calibrations that are fixed directly upon (or superimposed upon) the lens for close measurements of a plurality of metrics including but not limited to linear, angles, curves, squares, and circles. In another embodiment, various other measurements are directly fixed into the lens to enable easy usage by the user. As the user focuses on a certain subject image, these calibrations will overlay over the image thus enabling the user to quickly and accurately determine various measurements associated with the subject image.

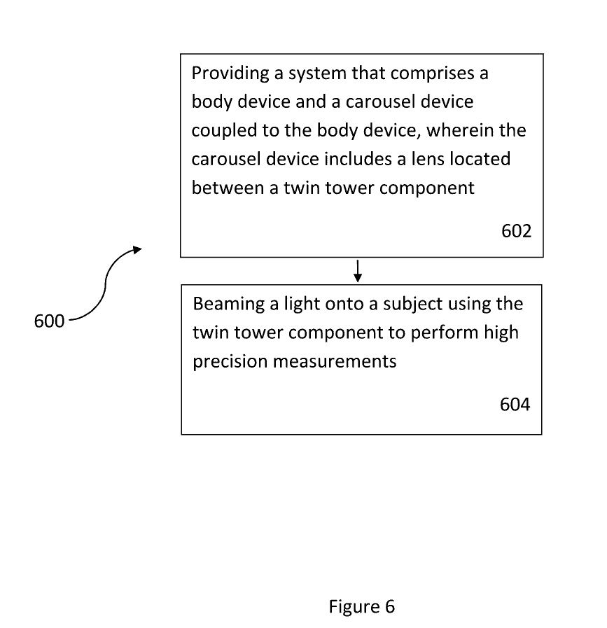

FIG. 6 a method 600 for performing high precision measurements using a metrology carousel device in accordance with an embodiment. The method 600 comprises providing a system that comprises a body device and a carousel device coupled to the body device, wherein the carousel device includes a lens located between a twin tower component, via step 602. The method 600 further comprises beaming a light onto a subject using the twin tower component to perform the high precision measurements, via step 604.

In one embodiment, a system for performing high precision measurements utilizes the method 600. The system is a metrology carousel device that comprises a body device, and a carousel device coupled to the body device, wherein the carousel device includes a lens located between a twin tower component. The twin tower component is used to beam light onto a subject to perform the high precision measurements. In one embodiment, the system further comprises a host device case, wherein the body device is coupled to the host device case and the host device case is therein coupled to a host device. In one embodiment, the host device is any of a mobile phone, a smartphone, and an iPhone.

In one embodiment, the lens is a macro-lens comprising optical polycarbonate. In another embodiment, the lens is a macro-lens comprising another optical grade material. The twin tower component comprises a first projection tower with a first embedded tower lens and a second projection tower with a second embedded tower lens. In another embodiment, the carousel device further includes a plurality of lenses (including but not limited to any of a macro-lens, micro-lens, wide-angle lens, and polarized neutral density lens) in addition to the lens positioned between the twin tower component. The carousel device is rotatable (in both clockwise and counter-clockwise directions) to enable selection of one of the plurality of lenses.

In one embodiment, the carousel device includes an opening (small hole) that accommodates a flash device (i.e., allows the flash to come through) and a microphone device (i.e., allows the sounds to come through) of the host device. In one embodiment, the system or metrology carousel device is a photo recordable super-caliper that is used in any of industrial, medical, and utility applications.

In one embodiment, the system further comprises a focal plane detector coupled to the twin tower component of the metrology carousel device, wherein the focal plane detector has a light source to beam the light onto the subject. In one embodiment, the light source is an internal light source (including but not limited to an optical grade channel overlay over the carousel device component that acts as a light pipe). In another embodiment, the light source is a light source borrowed/leveraged from the host device (smartphone).

In one embodiment, the system further comprises a software application coupled to the smartphone, wherein the software application communicates with the carousel device and at least the lens to provide variable and static scalar measurements. In one embodiment, the macro-lens is coupled to a metric display that is utilized to measure a square area around the subject. The metric display utilizes any of a metric system and an English system (and can interchange between them). In another embodiment, the macro-lens is coupled to the metric display that can project a linear and/or angular reticle that measures the live screen alternative to the measured square area around the subject.

In one embodiment, the metric display utilizes a plurality of modes comprising any of a live screen mode (live screen view) using at least the macro-lens (can use other lenses in this mode), a still photo library mode (still photo view) using at least the micro-lens (can use other lenses in this mode), an eZoom mode, and a streamline mode. In one embodiment, the twin tower component comprises two towers separated by a predetermined distance, wherein each of the two towers have a predetermined tower height, inner diameter, and outer diameter. In one embodiment, each of the two towers is movable to provide a coordinates variable focal length. In another embodiment, each of the two towers is stationary or one is movable and one is stationary or vice versa. In another embodiment, the plurality of lenses are flanked by a plurality of light towers and not just two.

As above described, the system and method provide a metrology carousel device for high precision measurements. The metrology carousel device includes a plurality of lenses (that are utilized using a rotatable mechanism) and the metrology carousel device can be easily coupled to a host device such as a smartphone (via a case or directly). The metrology carousel device is coupled over the embedded camera lens of the host device to enable the high precision measurements.

By integrating a twin tower design (two projecting structures) that can shine light beams onto the subject/object being viewed, the metrology carousel device determines a correct focal length to enable the high precision measurements to take place. The metrology carousel device includes a measuring square module that can overlay a square box over the object in view and determine various measurements such as the area and number of pixels within the square.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A system for performing high precision measurements, the system comprising:
a body device; and
a carousel device coupled to the body device, wherein the carousel device includes a lens located between a twin tower component, wherein the twin tower component is used to beam light onto a subject to perform the high precision measurements.

2. The system of claim 1, further comprising:
a host device case, wherein the body device is coupled to the host device case and the host device case is coupled to a host device.

3. The system of claim 2, wherein the host device is a smartphone.

4. The system of claim 1, wherein the lens is a macro-lens comprising optical polycarbonate.

5. The system of claim 1, wherein the twin tower component comprises a first projection tower with a first embedded tower lens and a second projection tower with a second embedded tower lens.

6. The system of claim 4, wherein the carousel device further includes a plurality of lenses in addition to the lens.

7. The system of claim 6, wherein the carousel device is rotatable to enable selection of one of the plurality of lenses.

8. The system of claim 6, wherein the plurality of lenses comprises any of a macro-lens, a micro-lens, a wide-angle lens, and a polarized neutral density lens.

9. The system of claim 2, wherein the carousel device further includes an opening that accommodates a flash device and a microphone device of the host device.

10. The system of claim 1, wherein the system is a photo recordable super-caliper that is used in any of industrial, medical, and utility applications.

11. The system of claim 3, further comprising:
a focal plane detector coupled to the twin tower component, wherein the focal plane detector has a light source to beam the light onto the subject.

12. The system of claim 11, wherein the light source is any of an internal light source or a light source from the smartphone.

13. The system of claim 12, wherein the internal light source comprises an optical grade channel overlay that acts as a light pipe.

14. The system of claim 3, further comprising:
a software application coupled to the smartphone, wherein the software application communicates with the carousel device and at least the lens to provide variable and static scalar measurements.

15. The system of claim 8, wherein the macro-lens is coupled to a metric display that is utilized to measure a square area around the subject.

16. The system of claim 15, wherein the metric display utilizes any of a metric system and an English system.

17. The system of claim 15, wherein the metric display utilizes a plurality of modes comprising any of a live screen mode using the macro-lens, a still photo library mode using the micro-lens, an eZoom mode, and a streaming mode.

18. The system of claim 1, wherein the twin tower component comprises two towers separated by a predetermine distance, wherein each of the two towers have a predetermined tower height, inner diameter, and outer diameter.

19. The system of claim 18, wherein each of the two towers is movable to provide a coordinates variable focal length.

20. A method for performing high precision measurements, the method comprising:
providing a system that comprises a body device and a carousel device coupled to the body device, wherein the carousel device includes a lens located between a twin tower component; and
beaming a light onto a subject using the twin tower component to perform the high precision measurements.
